(19) United States
(12) Patent Application Publication
(10) Pub. No.: US 2008/0071883 A1
(43) Pub. Date: Mar. 20, 2008

(54) Method and Apparatus for Proliferating Adoption of Web Components

(76) Inventor: Eric Alterman, New York, NY (US)

Correspondence Address: GOODWIN PROCTER LLP;PATENT ADMINISTRATOR, EXCHANGE PLACE, BOSTON, MA, 02109-2881, US

(21) Appl. No.: 11/781,416

(22) Filed: Jul. 23, 2007

Related U.S. Application Data
(60) Provisional application No. 60/846,068, filed on Sep. 20, 2006.

(51) Int. Cl. G06F 9/44; G06F 15/173

(52) U.S. Cl. 709/217; 717/106

(57) ABSTRACT

The invention provides a hosted application services platform and method its use that facilitates the proliferation of web-based components. The components include features, attributes and control objects that can be modified during design and after deployment. Instructions are provided that facilitate the expression of the features, attributes and control objects on web pages, and further allow for the copying of the components from website to website such that modifications to the features and/or attributes are automatically incorporated into the copied component whenever the component is expressed.

### CROSS-REFERENCE TO RELATED APPLICATIONS

This application claims priority to U.S. provisional patent application Ser. No. 60/846,068, on Sep. 20, 2006, the entire disclosure of which are incorporated herein by reference.

### FIELD OF THE INVENTION

The present invention concerns the sharing and proliferation of web-based components, and more particularly to a remote application platform that enables any website to create and serve components having a variety of customizable features.

### BACKGROUND OF THE INVENTION

The Internet generally and the World Wide Web (the “web”) in particular have changed the way information and media are published and shared. Whereas once only large, well-funded entities could afford to mass-market goods and services, the web provides a common, inexpensive platform with which anyone, from large corporations to individual teenagers, can reach millions of people. Recognizing the benefit of web-based marketing, advertisers have devised numerous methods and systems for delivering ads via websites.

In their most primitive form, web-based ads were static textual links on a web page that, upon selection by a visitor, would redirect the visitor's browser application to a different site. Soon, however, marketers realized that certain ads were more appealing to particular site visitors, and as a result, along with the advent of cookies and user profiles, targeted ads became the norm. As the number of web users grew, competition for their attention became more fierce, and sites were willing to pay other sites for referring visitors. Techniques such as pop-up ads and spam have also been used to entice web users to navigate to websites.

In each of these cases, however, companies wishing to place their ads on websites owned or operated by other parties are required to interact with the other party in some fashion. Whether it be through a direct advertising agreement, an affiliate agreement, or some other form of understanding, a company's ability to drive web traffic to its site has depended upon these relationships and is often directly limited by their number.

In other instances, companies have attempted to draw traffic by promulgating web-based components (e.g., ads interactive tools, media, etc.), making these components freely available to the general public. However, once the components are implemented at a target website, the company providing the component loses control of its use. If, for example, changes to the component are needed, a new “updated” component must be distributed. Similarly, if certain aspects of a component require updating, the entire component may need to be redesigned. Needless to say, development, maintenance and distribution of web-based components is a costly exercise.

### SUMMARY OF THE INVENTION

The invention provides a new technique and system that facilitate viral proliferation of web-based components such that the components are easily transferable from one website to another, but at the same time allow the originating designer to maintain control over and possibly change attributes and/or features of the components. By giving marketers the ability to build highly-portable, syndicated, web-based components, ads, media and premium content can be placed on virtually unlimited real estate across the web.

In accordance with the invention, a hosted development environment and techniques for its use allow users to design and implement web-based components that may be copied from one website to another, often without the knowledge or assistance of the designer, but still allow the designer to manipulate, change, and update features, functions and attributes of the component such that copies of the previously distributed components reflect subsequent changes. Furthermore, a web designer wishing to drive traffic to his site (either for advertising revenue, sales of products or services, or any number of other reasons) can entice casual visitors to “copy” certain interesting or compelling components to the visitor's site along with a link back to the designer's site. As such, the designer maintains control over the content being copied while increasing his potential to receive additional revenue from companies that advertise on his site.

In addition to facilitating the development and distribution of web-based components that refer back to a particular site, the invention also includes techniques and systems for keeping users engaged once they navigate to the site. In one example, the components provide a link to a common “community-based” website that in turn provides tools that allow visitors to register and build their own interactive personal spaces within the website. By offering easy-to-use tools for the development and deployment of media-management functions, blogging functions, and other interactive, personalized features, the invention increases the “stickiness” of the site, and thus enhances its value to potential advertisers.

Accordingly, in a first aspect, the invention provides a hosted application services platform that facilitates the proliferation of web-based components. The platform includes a component design module and a code-generation module. The component design module facilitates the design of the components, which include feature sets (media presentation, messaging, posting, etc.), attributes (e.g., size, color, skin, background, text, etc.) and at least one control object (e.g., a button, text box, drop-down box, and the like), which are initially determined during the design of the component. The design module also provides users with the ability to modify the feature set and/or the attributes of the component after deployment. The code-generation module generates instruction sets (e.g., javascript, markup instructions, XML, and similar instructions interpretable by web browser applications) for the component that express (e.g., render, play, display or somehow present to a user) the feature set, attributes and control object, the latter facilitating the seamless copying of the component from a first website to a second website such that, subsequent to the copying, modifications to the feature set and/or attributes are automatically incorporated into the copied component whenever it is expressed.

In some embodiments, the platform also includes a database for storing the feature sets and attribute sets of the components as periodically modified, and in some cases the code-generation module retrieves the feature sets and attribute sets from the database prior to generating the instruction set. The component can be virtually any element that may be expressed on a web page and viewed, heard or interacted with using a computer. More specifically, the component can be an advertisement and/or can display media content (e.g., audio, video, photos, or some combination thereof). The feature set can include, as examples, an upload feature (for uploading video clips, for example), a media viewing feature, a polling feature, a messaging feature (e.g., blogging, email, instant messaging, RSS and the like) and/or a navigation feature that in some instances refers users to the first website. In some versions in which the component includes a navigation feature, the component provides a portal to an application residing at the first website.

In some embodiments, the code-generation module can also express the feature set, attribute set and control object as updated such that the expression of the component reflects any modifications to the feature set, attribute set and/or control object. The instruction set can be ported among numerous websites, and as a result, the component may be seamlessly copied from the second website to a third website and subsequent updates to the feature set and/or the attribute set are automatically incorporated into the copied component whenever the copied component is expressed.

In another aspect, the invention provides a method for facilitating the proliferation of dynamic web-based components. A web-based component is designed, and includes a feature set and an attribute set. The feature set and attribute set may be fully or partially determined during the initial design of the components. The method also includes facilitating modification of the feature set and the attribute set after the component has been deployed and generating an instruction set (which may include, for example, a hostname and a component identifier) which, when interpreted, expresses the feature set and the attribute set for the component. In addition, the method includes facilitating the seamless copying of the component from a first website to a second website whereby subsequent to such copying, modifications to the feature set and/or the attribute set are automatically incorporated into the copied component whenever the component is expressed.

In other embodiments, the method also includes providing a control object to initiate the seamless copying from the first website to a second website. In addition, the the feature sets and attribute sets of the components can be stored in a database of the component as periodically modified. The feature sets and attribute sets can be retrieved from the database prior to generating the instruction set.

In some alternate embodiments, the feature set comprises a navigation feature that directs the client application to the first website at which a user can utilize an application which allows, among other functions, the creation of user-specific web pages, the uploading of media content to the user-specific web pages and/or the posting of text to the user-specific web pages.

In another aspect, the invention provides a method for facilitating the proliferation of dynamic web-based components. A dynamic web-based component is designed, and includes a feature set, an attribute set and at least one user control object for the component. The component is deployed on a first website, and once deployed, the component permits visitors to the first website to copy the component to a second website. Subsequent updates to one or more of the feature set or the attribute set are automatically incorporated into the copies of the component when it is expressed on the second website.

### BRIEF DESCRIPTION OF THE DRAWINGS

In the drawings, like reference characters generally refer to the same elements throughout the different views. Also, the drawings are not necessarily to scale, emphasis instead generally being placed upon illustrating the principles of the invention.

FIG. 1A is a block diagram of an environment in which the techniques described herein may be implemented according to various embodiments of the invention.

FIG. 1B is a screen capture of a website developed using the hosted application services platform in accordance with one embodiment of the invention.

FIG. 2 is a block diagram of an embodiment of a hosted application services platform according to various embodiments of the invention.

FIG. 3 is a flow chart illustrating the steps of designing and implementing dynamic web-based components according to various embodiments of the invention.

FIG. 4 is a block diagram of an embodiment of a server operating within the hosted application services platform of FIG. 2 in accordance with various embodiments of the invention.

FIG. 5 is a screen capture depicting various controls for designing web-based components in accordance with one embodiment of the invention.

FIG. 6 is a screen capture depicting additional controls for designing web-based components in accordance with one embodiment of the invention.

FIG. 7 is a screen capture depicting additional controls for designing web-based components in accordance with one embodiment of the invention

FIG. 8 is a screen capture depicting additional controls for designing web-based components in accordance with one embodiment of the invention.

FIG. 9 is a screen capture depicting additional controls for designing web-based components in accordance with one embodiment of the invention.

FIG. 10 is a screen capture depicting additional controls for designing web-based components in accordance with one embodiment of the invention.

### DETAILED DESCRIPTION

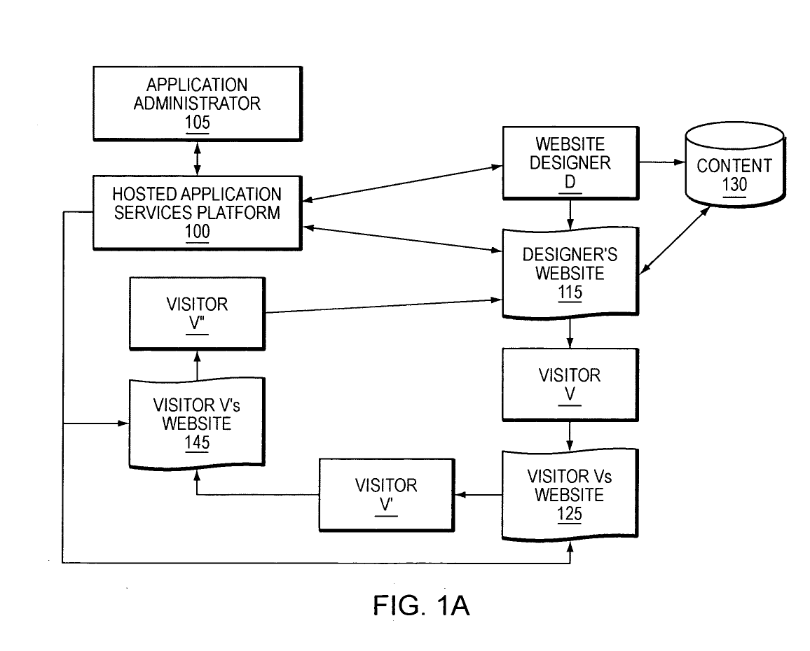

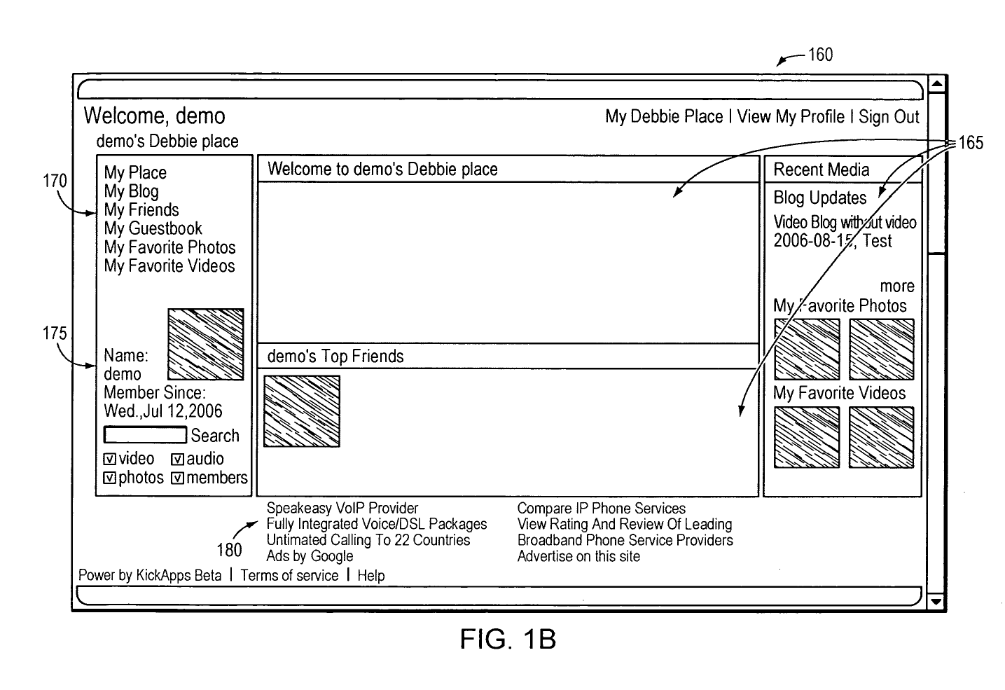

Referring to FIG. 1A, in one embodiment, an exemplary hosted application services platform 100 is operated by (or on behalf of) an application administrator(s) 105 responsible for the overall implementation and operation of the platform 100. The platform 100 provides the infrastructure, systems, communications and processing functionality that allows website designers D (and in some instances visitors to sites designed by designers D to design web-based components (also referred to herein as “widgets”) and web pages associated with a website 115. When expressed in a browser application, the components allow visitors to the site 115 to view and interact with them as integral elements of the web pages. Further, because the components are stored centrally and the proliferation of the components is effectuated using script files that can be copied from website to website, the designer D can maintain ongoing control over and manipulate the functionality, features and attributes of components she designed. Furthermore, without necessarily having any knowledge of the websites to which the component has been copied, the designer D can be assured that her changes will take effect at each site when the component is next expressed.

In general, the website designer D uses the platform 100 to develop components that implement various functions on his website 115 such as login and registration, messaging and posting (e.g., RSS feeds and blogs), search functions, media upload and playback, as well as components that combine one or more of these functions. In some embodiments, the components are used to implement various social networking and community-based features at the website 115, such as the creation of a “personal web page” or “my page” by a visitor V to the website 115. Because such features allow visitor 120 to design his own personalized pages within website 115 (or in some cases a different website 125 attributed to the visitor V), he is more likely to return to the website 115, refer friends to the website 115, and generally spend more time searching and viewing individual pages the website 115. Such increased usage, or “stickiness” is a chief objective of many websites because evidence of high usage, pageviews and/or registered users is likely to attract advertisers to the site and receive revenue (through, for example, affiliate advertising agreements and other “click-through” type arrangements) as users navigate through the site, view content, and are presented advertisements.

In addition, the designer D may combine components developed using the platform 100 with additional content 130. As used herein, content 130 can be any form of media, text or graphics owned, licensed, or used by or on behalf of the designer D. For example, designer D may be designing the website 115 on behalf of a consumer product company, in which case the content 130 may include static advertisements, commercials (both audio and video), text describing the products offered, images such as logos and pictures of new products, and similar marketing materials related to the company's brands. The components and content 130 may be combined according to templates, style sheets (e.g., CSS) or manually included in source code for web pages (e.g., HTML for example) such that when expressed by a browser application, present the user with a web page. The components can, in some instances, be assigned to specific positions on the web page that are not part of the main portion of the page (e.g., a banner advertisement, a footer, a sidebar, or a particular cell within a table), or in some cases the entire page may be comprised of components. In some embodiments, content 130 may be integrated into components, such that the components present the content according to a particular design or along with features as determined by the designer D.

In addition to allowing users to interact with and use the components as implemented on the designer's website 115, a preferred feature of the invention allows visitor V to copy components from the designer's website 115 to his own website 125. In some embodiments the components include a control object (e.g., a graphical representation of a button) that, when selected, presents the visitors with a code snippet (e.g., a script, pointer, or other text) that can be sent to the platform 100 based on a visitor's request of the page on which the component is placed. The snippet identifies the component to the platform 100 such that the platform 100 can, for example, retrieve the appropriate attributes from a database and provide the appropriate instructions to the requesting application for presentation (e.g., as graphical content, audio content, or both) to the visitor. The code snippet may be, for example, one or more javascript commands that may include an HTTP request to the platform 100 that uniquely identifies the component, instructs the platform 100 to retrieve the features, functions and attributes of the component, generate instructions for rendering the component, and transmit the instructions to the requesting client for expression and presentation to the user. In some cases, the instructions are generated in the form a markup language (e.g., XML), an example of which is attached hereto as Appendix A.

Once visitor V copes a component from the designer's website 115 to his website 125 or page, subsequent visitors (e.g., visitor V′) can copy the component to her website or page 145, where, for example another visitor V″ can view and interact with the component. In each case, the component need not actually reside on the server or system of the designer or visitor, as the component is served to the sites 115, 125 and 145 by the platform 100. In addition, visitors choosing to interact with the component by, for example, viewing a video listed or previewed by the component, may be redirected to the designer's website 115, which, by increasing traffic and pageviews at the site 115, adds to its value as an advertising and media distribution platform. For example, a visitor V″ may be viewing visitors V's website 145, and decide that he is interested in one or more of the media files listed in a component on the site 145. Visitor V″, having no knowledge that the component was actually copied from the designer's site 125, clicks on an element of the media (e.g., a hyperlink, thumbnail or other identifying text), and, because the component is identified at the platform as originating with designer D, requests from visitor V″ to view the component are redirected to designer D's web page 115.

FIG. 1B illustrates an example of a web page 160 comprising various components 165 designed and implemented using the platform 100. For example, components 165 may include a blog component that allows visitors to post comments and messages on the web page, a media display component that includes thumbnail images from photos and/or videos selected by the designer, a friends listing component that lists other users that have identified themselves as friends of the designer, search components, as well as other features and functions common to social networking and media sharing sites. The page 160 also includes a menu listing 170 of the functions available to visitors to the site, each of which may be implemented using one or more components developed using the platform 100. In some embodiments, the page 160 also includes a user identification component 175 that displays the user name associated with the designer of the page 160 as well as other information regarding the designer D. Advertisements 180 may also be included on the web page 160, either as static text such that each user sees the same ad each visit to the site, or as dynamic ads that can change for each viewing. In some embodiments, the dynamic ads may be served by a third party, such as Google or Yahoo, in which case the site designer D may receive compensation for allowing the ads to be placed on the website 160.

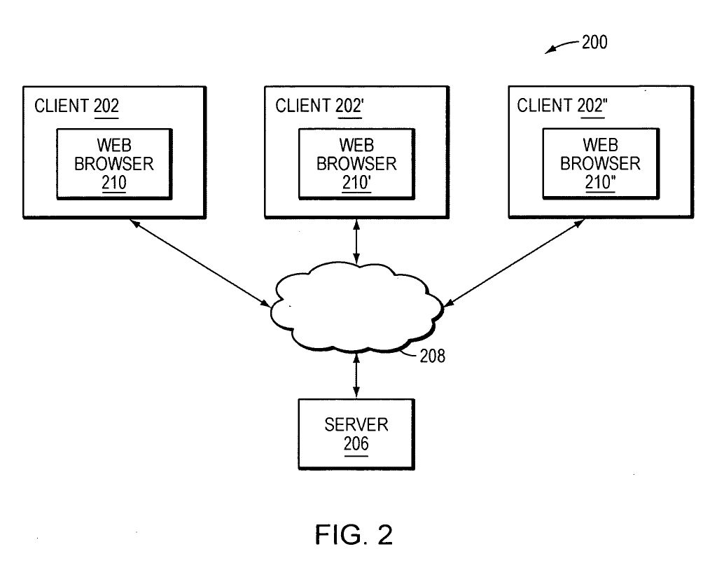

Referring to FIG. 2, in one embodiment, the domain 200 in which the platform 100 operates includes at least one server 206, typically hosted by or on behalf of the application administrator, and at least one client 202, 202′, 202″ (generally 202) used by the website designer and/or site visitors. In some embodiments, communication among the server 206 and one or more of the clients 202 occurs over a communications network 208. As shown, the system 200 includes three clients 202, but this is only for exemplary purposes, and it is intended that there can be any number of clients 202. The client 202 is preferably implemented as software running on a personal computer (e.g., a PC with an INTEL processor or an APPLE MACINTOSH) capable of running such operating systems as the MICROSOFT WINDOWS family of operating systems from Microsoft Corporation of Redmond, Wash., the MACINTOSH operating system from Apple Computer of Cupertino, Calif., and various varieties of Unix, such as SUN SOLARIS from SUN MICROSYSTEMS, and GNU/Linux from RED HAT, INC. of Durham, N.C. (and others). The client 202 can also be implemented on such hardware as a smart or dumb terminal, network computer, wireless device, wireless telephone, information appliance, workstation, minicomputer, mainframe computer, or other computing device that is operated as a general purpose computer or a special purpose hardware device used solely for serving as a client 202 in the system 200.

Generally, in some embodiments, clients 202 can be operated and used by website designers, web masters, marketers, and others responsible for developing, providing and/or approving content for websites and to interact with the platform 100. Examples of such activities include, but are not limited to, developing components for managing the uploading, approval and distribution of media, as described in currently-pending U.S. patent application Ser. No. 11/088,244, entitled “Method and Apparatus for Storing and Accessing Videos From a Remote Location,” the entire disclosure of which is incorporated by reference herein. Clients 202 can also be operated by third-party entities (e.g., consultants, site visitors, etc.) that perform other administrative tasks for users of the platform. Such activities include using the clients 202 to build personal pages, design content, submit content, comment on existing content, as well as other activities described herein.

In various embodiments, the client computer 202 includes a web browser 210. The web browser 210 allows the client 202 to request a web page or other downloadable program, applet, or document (e.g., from the server 206) with a web page request. One example of a web page is a data file that includes computer-executable or interpretable information, graphics, sound, text, and/or video, that can be displayed, executed, played, processed, streamed, and/or stored and that can contain links, or pointers, to other web pages. In one embodiment, a user of the client 202 manually requests a web page from the server 206. Alternatively, the client 202 automatically makes requests with the web browser 210. Examples of commercially available web browser software 210 are INTERNET EXPLORER, offered by Microsoft Corporation, NETSCAPE NAVIGATOR, offered by AOL/Time Warner, and FIREFOX offered by the Mozilla Foundation.

The communications network 208 connects the client 202 with the server 206. The communication may take place via any media such as standard telephone lines, a local or wide-area network (LAN or WAN links such as T1, T3, 56 kb, X.25), broadband connections (ISDN, Frame Relay, ATM), wireless links (cellular, 802.11, Bluetooth, etc.), and so on. Preferably, the network 208 facilitates the transmission of TCP/IP protocol communications and HTTP/HTTPS requests or postings made by the web browser 210 and/or the server 206, which can be communicated over such TCP/IP networks. The type of network is not a limitation, however, and any suitable network may be used. Non-limiting examples of networks that can serve as or be part of the communications network 208 include a wireless or wired Ethernet-based intranet, LAN or WAN, and/or the global communications network known as the Internet, which may accommodate many different communications media and protocols.

The server 206 interacts with clients 202. The server 206 is preferably implemented on one or more server-class computers that have sufficient memory, data storage, and processing power and that run a server-class operating system (e.g., SUN Solaris, GNU/Linux, and the MICROSOFT WINDOWS family of operating systems). Other types of system hardware and software may also be used, depending on the capacity of the device and the number of users and the size of the user base. For example, the server 206 may be or may be part of a logical group of one or more servers such as a server farm or server network. As another example, multiple servers 206 can be associated or connected with each other, or multiple servers may operate independently, but with shared data. In a further embodiment and as is typical in large-scale systems, application software is implemented in components, with different components running on different server computers, on the same server, or some combination.

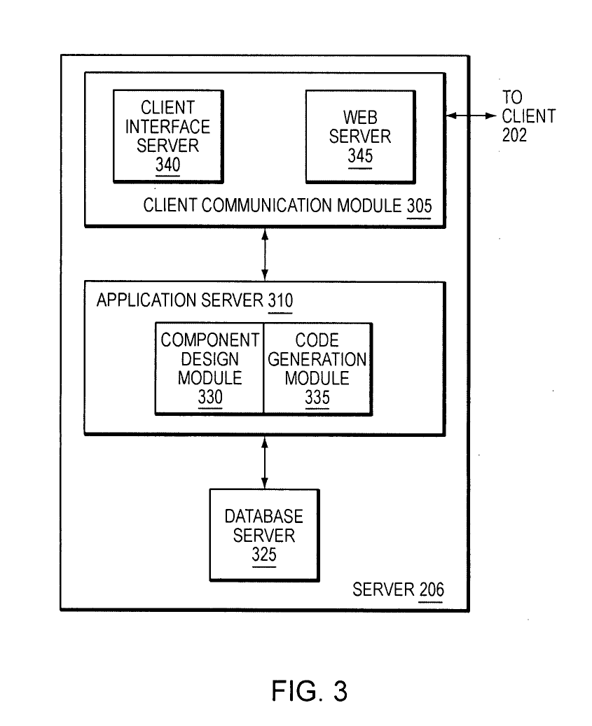

Referring to FIG. 3, in one embodiment, the server 206 includes a client communication module 305 that provides a communication interface with clients 202. The client communication module 305 can be implemented as software running on one or more servers, or may be implemented as a stand-alone server. In some embodiments, the client communication module 305 provides an interface to a client web browser 210, so that, for example, a web browser 210 can be used by a developer to access and modify components and page designs.

The client communication module 305 communicates with an application server 310, which provides a platform on which the main programming logic of the platform is stored, called and executed. In one embodiment, the application server 310 is implemented as one or more application programs running on a server-class computer, which may be the same computer as the client communication module 305 or a different computer. The application server 310 receives instructions and requests from web designers, site visitors and others via the client communication module 305, typically in the form of HTTP requests. The application server 310 also provides the infrastructure for implementing the functionality described below. For example, the application server 310 provides the various component design instructions and options from which website designers select various features and functions to be included in the component. As another example, in some embodiments the application server 320 provides a mechanism for generating coding instructions that allow the propagation of the components to various websites according to the techniques described herein.

The server 206, in some embodiments, also includes a database server 325, which stores data related to the components, users of the platform, web pages on which the components have been implemented, and other data used by the application server 310. For instance, the database server 325 may store information relating to the attributes and features of the components (e.g., titles, hex values of colors for the background and border, .jpg images to be used as a background, text, etc.), user information and communication and usage logs. The database server 325 may also contain separate databases for user data, membership data, media content, user permissions and security information, and others. The database server 325 provides data to the application server 310 for inclusion in messages, web pages, stored procedures, and applications (both residing on the client and/or the server).

The data can, in some instances, be stored in one or more databases. The database server 325 can also store data relating the use and performance of the platform itself, such as server availability and web traffic information. Examples of database applications that can be used to implement the database server 330 include MySQL Database Server by MySQL AB of Uppsala, Sweden, the PostgreSQL Database Server by the PostgreSQL Global Development Group of Berkeley, Calif., and the ORACLE Database Server offered by ORACLE Corp. of Redwood Shores, Calif.

In one embodiment, the client communication module 305 includes a client interface server 340, which provides an interface for communications with the clients 202. In one embodiment, the client interface server 340 is a software module executing on a server computer 206. In another embodiment, the client interface server is a stand-alone server computer in communication with other components of the server 206, such as the application server 310. In one embodiment, the client interface server 340 communicates with software operating on the clients 202 using a messaging protocol that runs over TCP/IP for communications between the client and the client interface server 340. The client interface server 335 is designed to maintain communications with a large number of clients 202. In some embodiments, the communication server is or operates as part of the server 206 as described above, whereas in other cases the communication server may be a separate server, which may be operated by and/or outsourced to an application service provider (ASP), internet service provider (ISP), or other third-party. In various embodiments, the communication server facilitates HTTP/S requests and responses, Java messages, SMTP messages, POP3 messages, instant messages, RSS feeds, as well as other electronic messages exchanged among users of the investment information domain.

In some embodiments, the client 202 may communicate with the server 206 via a web browser 210. In such an embodiment, the communication module 305 also includes a web server 345. The web server 345 delivers web pages to the client 202 and provides an interface for communications between the web browser 210 and the server 206. Preferably, the web server 345 is an enterprise class web server, such as APACHE from the APACHE FOUNDATION, MICROSOFT WEB SERVER from MICROSOFT CORPORATION, or NETSCAPE ENTERPRISE SERVER from NETSCAPE COMMUNICATIONS CORPORATION, running on one or more server class computers, which may be the same or different computers than the client interface server 340. The web server 345 may be implemented as any communications device that is capable of serving web content to client web browsers 210 over the communications network 208, and communicating with the other parts of the server 206. For example, the web server 345 may be a personal computer, a web appliance and so on. The web server 345 and the client interface server 340 are each in communication with the application server 310.

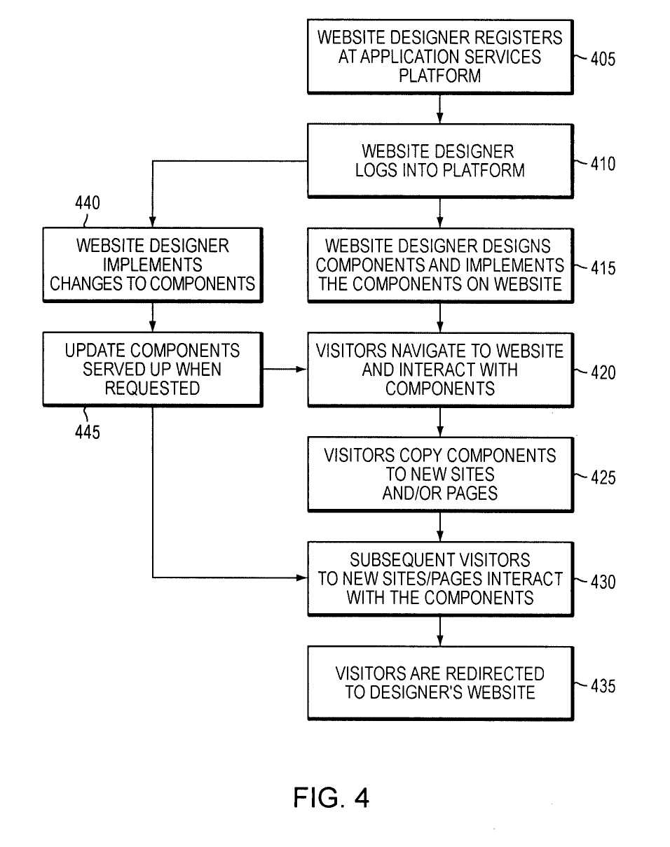

FIG. 4 illustrates a process for the design and proliferation of dynamic web-based components in accordance with various embodiments of the invention. Initially, a website designer contacts the application services platform (by, for example, navigating to a home page or other designated web page attributed to the platform) and registers to use the platform (STEP 405). As one example in which the website relates to a particular company, the designer provides the URL of the site, bitmaps or .jpg files containing logos or trademarks of the company to be used in the development of the components, media files to be presented to users visiting and/or interacting with the website and/or components, user registration information such as a user name, password, email address and other company information. In some embodiments, the designer provides certain information about the website into which the components will be integrated, such as layouts, templates, color schemes, sizing information, and the like. Once registered, the designer (or other users acting on behalf of the designer or organization) logs into the platform (STEP 410) and begins the design process (STEP 415).

As part of the design process, the designer can specify various features and attributes of the components, as described in greater detail below, that permit a visitor navigating to the site to interact with the site (STEP 420) by, for example, creating her own personal “space” on the website (e.g., one or more uniquely addressable web pages attributed to the user), uploading video clips, maintaining a blog, receiving RSS feeds, and interacting with other users. Because the platform provides the designer with numerous design and attribute options (e.g., color, background, skin, functionality, etc.) the components can be highly customized for a particular site. For example, the company hosting the website may include its logo as the background for the component, and as a result, every copy of the component that is copied onto other sites also includes the logo. Thus, without having to communicate with or contract with any of the various sites or individuals that copy the component, the company receives advertising “real estate” on the various sites.

If the designer has included a control object that facilitates the copying of the component from site to site, a visitor to the site interested in the component can copy the component (or components) to their own website (STEP 425) or a web page assigned to them by, for example, a social networking site such as MYSPACE.COM or FACEBOOK. The user copies the component by activating the control object (e.g., if the control object is a representation of a button, by clicking on the button). As a result, code elements (generated, for example, by the code generation module) are copied to the visitor's clipboard, and are available for copying into their own web page files. In copying the component to their site or pages, the visitor now provides subsequent visitors to her site with access to the same media, functions, and features that exist on the initial website. In some embodiments, when a subsequent visitor interacts (STEP 430) with the component on the visitor's site, the subsequent visitor is redirected (STEP 435) to the original site, again providing additional traffic and page views for the original site. As the component is copied from site to site, it proliferates across the web and provides numerous portals back to the original site, all the while maintaining the branding attributes associated with the component.

In some embodiments, the designer of the original component may want to modify or update the component (STEP 440) in order to change the branding of the component. Such modification may be accomplished manually by, for example, the designer logging into the platform and changing or updating the features, functions and/or attributes of the components. Modifications may also (or alternatively) occur automatically (e.g., based on a computed statistic such as views, ratings, or time since uploaded). For example, a component may be designed to present the top ten videos as rated by visitors to the website. As new videos are added and visitors view and rate the videos, the videos that reflect the “top ten” will change. As the list of videos changes, the titles and previews shown in the component change at each site to which the component has been copied. In another example, the website that designed and originally hosted the component may wish from time to time to distribute premium content, such a movie trailers or sports highlights. Again, as the specific media changes, the media displayed in each of the copied components changes, even though the overall feature set and other attributes of the component may remain unchanged. This is facilitated by storing the features and attributes of the components at a central location (in, for example a database) and retrieving the features when a visitor's browser executes code attributed to (and uniquely identifying) a particular component and directed to the platform.

In some cases, the website hosting the component may enter into an advertising agreement with a consumer product company and offer to place an advertisement, logo, trademark, or some other means to identify the company in the component. The hosting site can offer the company not only the capabilities provided by its own site, but by making the component interactive and media-rich, increases the chance that the component will be copied by site visitors, such that the advertisement spreads virally across the web. Furthermore, when the agreement between the advertiser and the site hosting the component terminates, the site can offer to place an ad for another company in the component, which has already been distributed to a large number of sites. For example, a web site designer may design a component using the logo's, colors, and other branding characteristics of a soft-drink company and include with the component videos of outdoor activities, thus appealing to a particular demographic. Over time, the component spreads from web site to web site, increasing its exposure. Subsequently, the designer may contract with a new company (e.g., an automobile manufacturer looking to launch a new model) wishing to target a similar demographic, or merely interested in reaching a large number of potential customers. The designer can modify the component by updating the branding characteristics used as attributes of the component stored in the database with those of the auto manufacturer. Immediately, all subsequent expressions of the component include the colors, logos, trademarks, images and other attributes of the auto manufacturer. As such, the advertiser has a more compelling reason to engage the hosting site as an advertising partner, and the value of the opportunity is greatly increased for both parties as the component proliferates across the web.

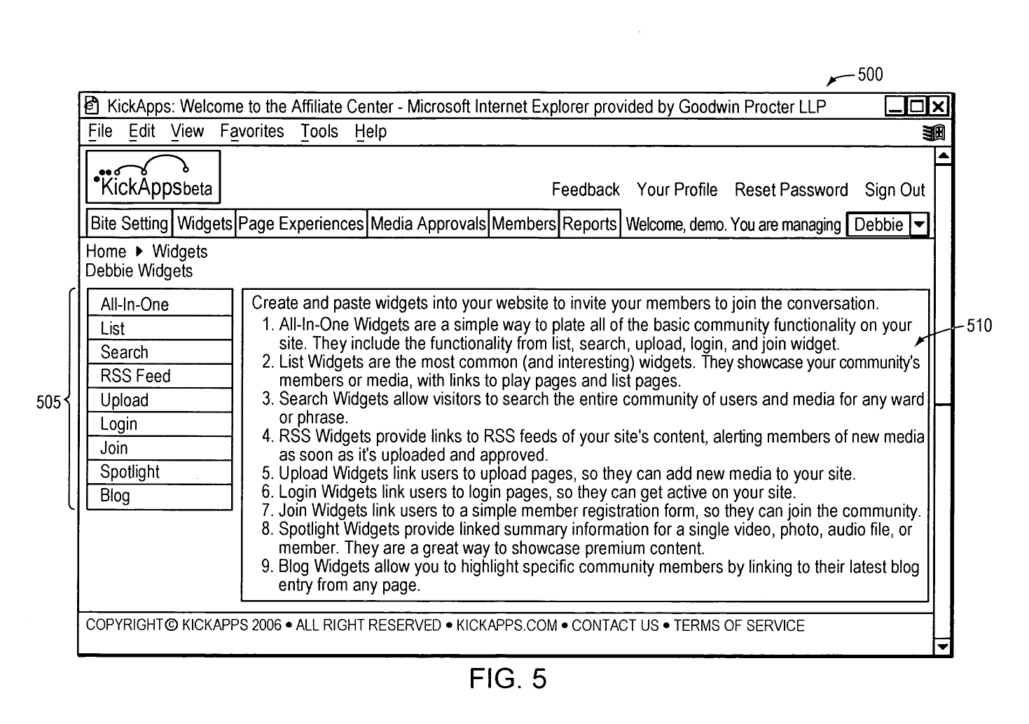

FIGS. 5 though 10 are representative screen captures from a application that provides site designers with access to the platform and facilitates the design and development of components. More specifically, FIG. 5 is a screen capture of an exemplary initial component-development screen 500 on which a user of the application can select from a list 505 of the types of components available, and brief descriptions 510 of the functionality of each type of component.

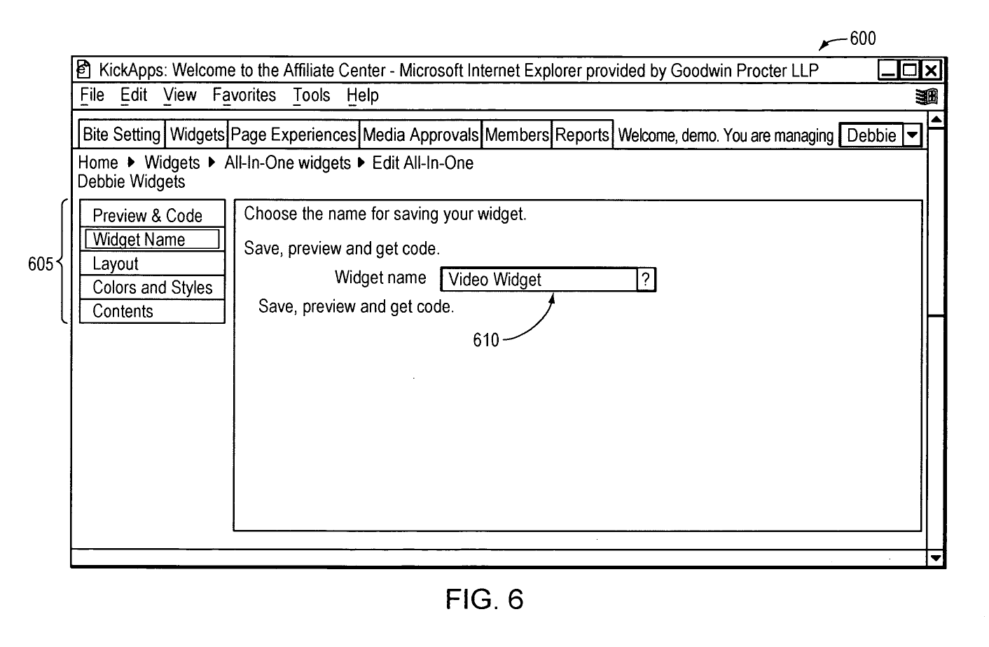

FIG. 6 is a screen capture of an exemplary component definition screen 500 on which a user of the application is presented a listing 605 of various groups of attributes of the component. As one example, screen 600 presents the user with a name text field 610 into which the user may type a component name to identify the component and recall if for subsequent editing and deployment.

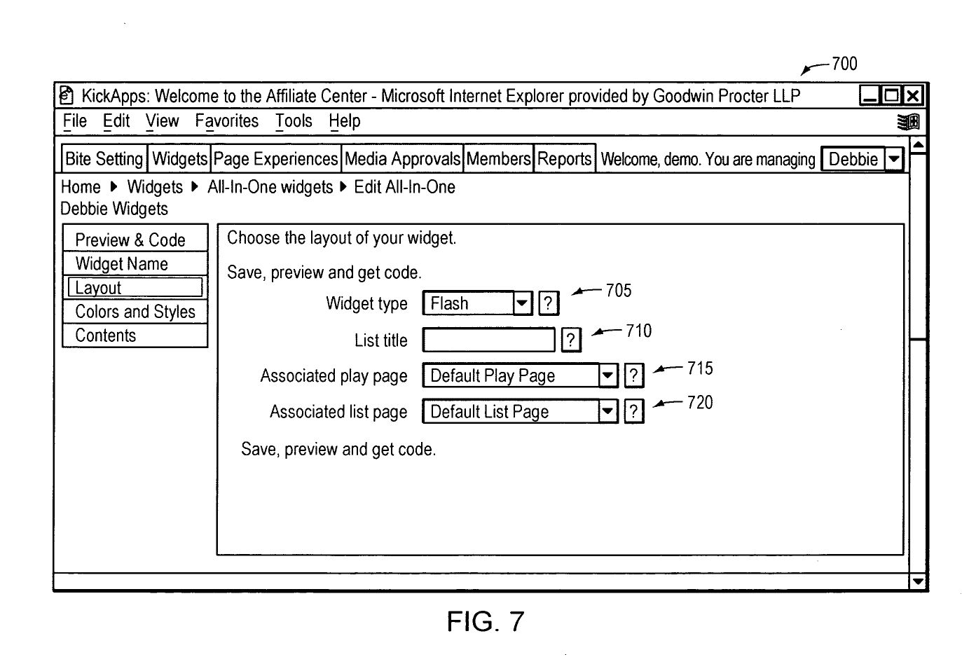

FIG. 7 is a screen capture of an exemplary component-definition screen 700 on which the user provides additional attributes for the component such as the type of component 705 (e.g., HTML or FLASH), a title 710 (which, for example, may be the tile of a list of content or media presented in the component), an associated play page 715 (e.g., a web page to which a user is redirected when he selects content or media presented in the component) and an associated list page 720 (e.g., a web page to which a user is redirected when he requests additional information or content associated with the component but not displayed) select content or media presented in the component).

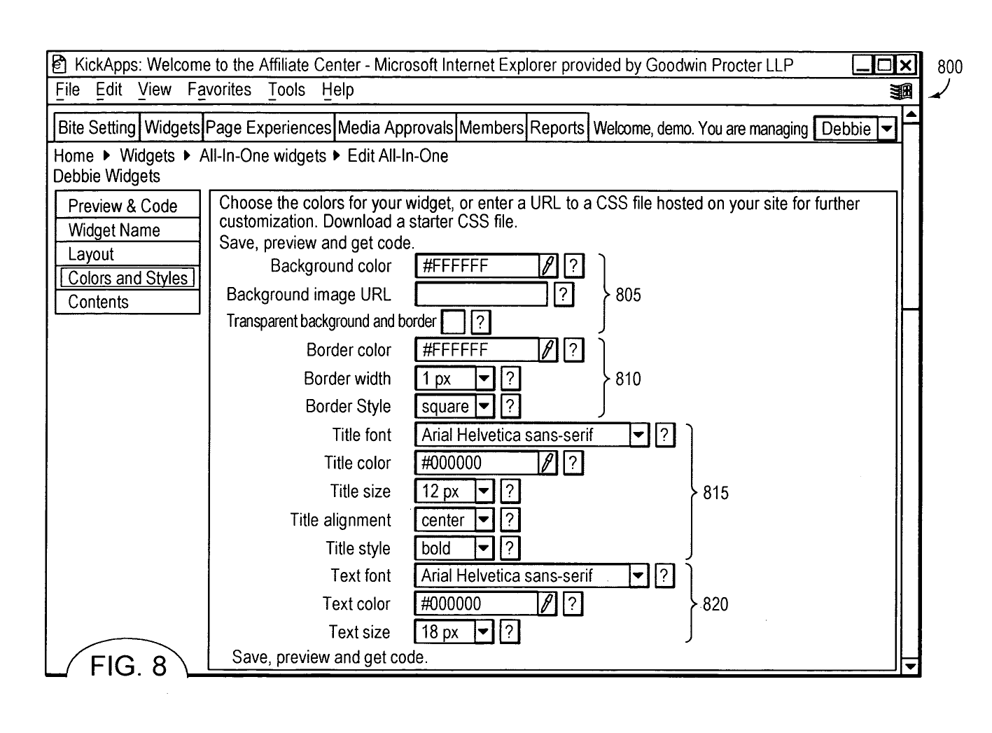

FIG. 8 is a screen capture of an exemplary component-definition screen 800 on which the user selects various aesthetic attributes of the component. For example, background fields 805 facilitate the selection of a background color and/or image. Border definition fields 810 allow the user to define the color, width and style of the border surrounding the component. Title fields 815 relate to the font, color, size, alignment and style used to present the title of the component when expressed. Text fields 820 provide similar functionality related to the text displayed within the body of the component.

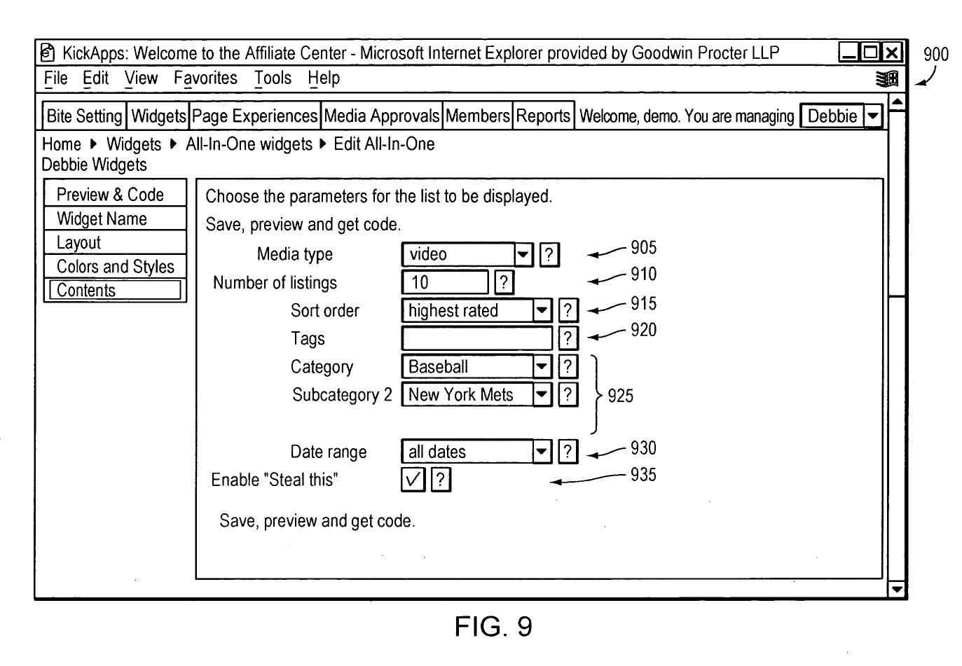

FIG. 9 is a screen capture of an exemplary component-definition screen 900 at which the user can define various contents of the component. For example, field 905 facilitates the selection of a media type (e.g., video, audio, photograph, etc.) that is to be presented in the component. Listings field 910 allows the user to specify the number of media elements that are to be displayed at any one time. Sort Order field 915 provides the user with the ability to specify and alter the order the media is presented in the component. For example, the media may be presented based on a composite rating received from other users, the date the media was submitted (e.g., most recent first) or the number of times the media has been viewed. Tags field 920 allows the user to provide one or more keywords that may be used to search for and identify content that has been tagged with similar keywords. For example, the user may defined a component that presents previews for the ten most recently uploaded videos that have a keyword of “baseball.” Category fields 925 provide additional classification features that allow the user to categorize the component by one or more categories and/or subcategories. A date range field 930 provides additional filtering capabilities such that the component is limited to recently uploaded media (e.g., last seven days, previous week, etc.). Check box 935, when selected, implements functionality that allows visitors to the website hosting the component to “copy” the component onto another website, while maintaining a link back to the source web page and/or community site and allowing the designer of the component to maintain control over the features and attributes of the component, regardless of the sites to which the component as proliferated.

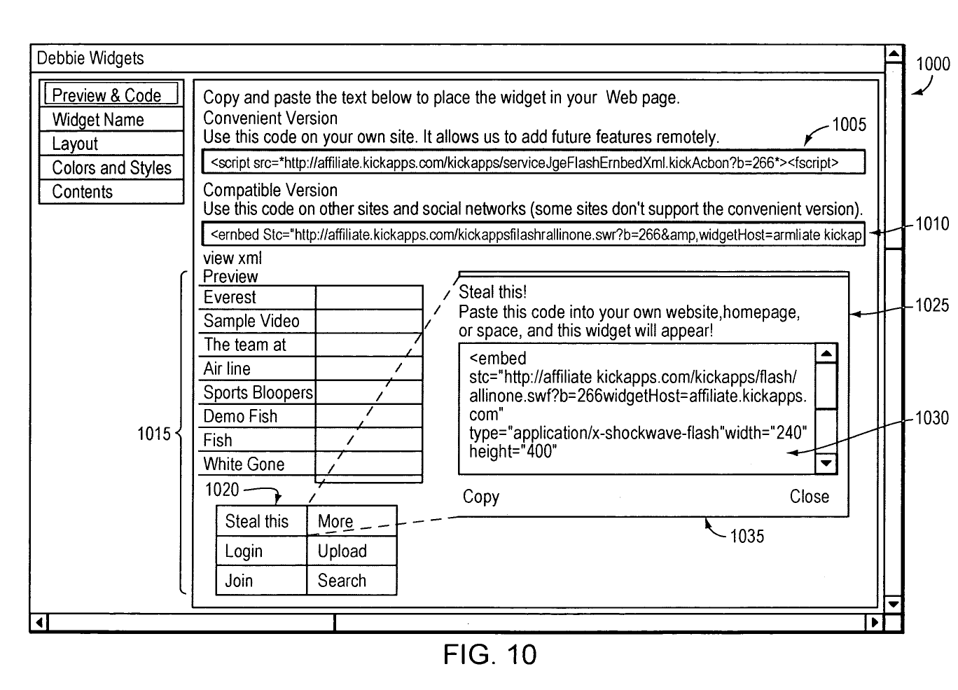

FIG. 10 is a screen capture of an exemplary component screen 1000 at which the user can review the design and attributes of the component. Source code fields 1005 and 1010 provide the user with a preview of the source code (e.g., script) that can be copied into the visitor's web page such that the component appears on the page with it is rendered by a browser application. In some embodiments, the code may include a unique component identifier, a hostname, an affiliate identifier, and other information related to the display parameters of the component 1015. In some instances, the component 1015 includes a control object 1020 that facilitates the copying of the component from one website to another. When selected, the control object 1020 presents the designer with a screen 1025 showing what visitors to the designer's website will be presented when she selects the control object. The screen 1025 includes code 1030 that instructs a browser to contact the platform and retrieve the features and attributes of the component 1015 and send the instructions for expressing the component 1015. Copy button 1035 facilitates the copying by placing a copy of the code in a memory space as allocated by a client machine, such as the clipboard in WINDOWS-based clients.

The invention may be embodied in other specific forms without departing form the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

```
APPENDIX A
    <?xml version=“1.0” encoding=“UTF-8” ?>
  - <W affiliateSiteId=“42” type=“AllinOne” widgetId=“3264” mediaType=“−1”
  affiliateSiteName=“Debbie” affiliateSiteURL=“www.demo12345678.com”
        widgetHost=“affiliate.kickapps.com”>
  <E name=“mediaFileType” value=“Flash” />
  <E name=“title” value=“”/>
  <E name=“playPage” value=“1” />
  <E name=“listPage” value=“1” />
  <E name=“bgColor” value=“#FFFFFF” />
  <E name=“backgroundImageUrl” value=“” />
  <E name=“transparentBackgroundBorder” value=“false” />
  <E name=“borderColor” value=“#FFFFFF” />
  <E name=“borderWidth” value=“1” />
  <E name=“borderStyle” value=“1” />
  <E name=“titleFontFace” value=“Arial,Helvetica,sans-serif” />
  <E name=“titleFontColor” value=“#000000” />
  <E name=“titleFontSize” value=“12” />
  <E name=“titleAlignment” value=“1” />
  <E name=“titleStyle” value=“2” />
  <E name=“textFontFace” value=“Arial,Helvetica,sans-serif” />
  <E name=“textFontColor” vaule=“#000000” />
  <E name=“textFontsize” value=“18” />
  <E name=“mediaType” value=“1” />
  <E name=“stealThisBean” value=“true” />
- <E name=“video” value=“”>
  <SE name=“views” value=“9” />
  <SE name=“name” value=“Everest” />
  <SE name=“description” value=“Is she really climbing this mountain?” />
  <SE name=“dateCreated” value=“Wed, Jul 12, 08:38 AM” />
  <SE name=“votes” value=“0” />
  <SE name=“rating” value=“0.0” />
  <SE name=“uploadedByUrl” value=“http://affiliate.kickapps.com/kickapps/service/displayKickPlace.kickAction?u=165&as=42” />
  <SE name=“count” value=“0” />
  <SE name=“thumbnail” value=“http://static.kickapps.com/kickapps/images/default/photos/VIDEO_2_1_ap.jpg” />
  <SE name=“thumb_100_75” value=“http://static.kickapps.com/kickapps/images/default/photos/VIDEO_2_1_ap_100X75.jpg” />
  <SE name=“thumb_160_120” value=“http://static.kickapps.com/kickapps/images/default/photos/VIDEO_2_1_ap_160X120.jpg” />
  <SE name=“thumb_320_240” value=“http://static.kickapps.com/kickapps/images/default/photos/VIDEO_2_1_ap_320X240.jpg” />
  <SE name=“thumb_48_48” value=“http://static.kickapps.com/kickapps/images/default/photos/VIDEO_2_1_ap_48X48.jpg” />
  <SE name=“uploadedByName” value=“eric” />
  <SE name=“url” value=“http://affiliate.kickapps.com/kickapps/service/
  displayMediaPlayPage.kickAction?mediaId=281&mediaType=VIDEO&as=42&b=3264” />
  <SE name =“uploadedByThumbnail” value=“http://static.kickapps.com/kickapps/images/default/users/eric_1_buddyIcon.jpg” />
  <SE name=“id” value=“281” />
      </E>
- <E name=“video” value=“”>
  <SE name=“views” value=“66” />
  <SE name=“name” value=“Sample Video” />
  <SE name=“description” value=“Lonely girl. I hope some one can help her out.” />
  <SE name=“dateCreated” value=“Wed, Jul 12, 08:38 AM” />
  <SE name=“votes” value=“1” />
  <SE name=“rating” value=“3.0” />
  <SE name=“uploadedByUrl” value=“http://affiliate.kickapps.com/kickapps/service/displayKickPlace.kickAction?u=166&as=42” />
  <SE name=“count” value=“1” />
  <SE name=“thumbnail” value=“http://static.kickapps.com/kickapps/images/default/photos/VIDEO_3_1_ap.jpg” />
  <SE name=“thumb_100_75” value=“http://static.kickapps.com/kickapps/images/default/photos/VIDEO_3_1_ap_100X75.jpg” />
  <SE name=“thumb_160_120” value=“http://static.kickapps.com/kickapps/images/default/photos/VIDEO_3_1_ap_160X120.jpg” />
  <SE name=“thumb_320_240” value=“http://static.kickapps.com/kickapps/images/default/photos/VIDEO_3_1_ap_320X240.jpg” />
  <SE name=“thumb_48_48” value=“http://static.kickapps.com/kickapps/images/default/photos/VIDEO_3_1_ap_48X48.jpg” />
  <SE name=“uploadedByName” value=“Pete” />
  <SE name=“url” value=“http://affiliate.kickapps.com/kickapps/service/
  displayMediaPlayPage.kickAction?mediaId=282&mediaType=VIDEO&as=42&b=3264” />
  <SE namE=“uploadedByThumbnail” value=“http://static.kickapps.com/kickapps/images/default/users/pete_1_buddyIcon.jpg” />
  <SE name=“id” value=“282” />
      </E>
- <E name=“video” value=“”>
  <SE name=“views” value=“48” />
  <SE name=“name” value=“The team at work” />
  <SE name=“description” value=“” />
  <SE name=“dateCreated” value=“Wed, Jul 12, 08:54 AM” />
  <SE name=“votes” value=“1” />
  <SE name=“rating” value=“5.0” />
  <SE name=“uploadedByUrl” value=“http://affiliate.kickapps.com/kickapps/service/displayKickPlace.kickAction?u=173&as=42” />
  <SE name=“count” value=“2” />
  <SE name=“thumbnail” value=“http://static.kickapps.com/kickapps/images/videos/289_tmb/289_tmb0003.jpg” />
  <SE name=“thumb_100_75” value=“http://static.kickapps.com/kickapps/images/videos/289_tmb/289_tmb0003.jpg” />
  <SE name=“thumb_160_120” value=“http://static.kickapps.com/kickapps/images/videos/289_tmb/289_tmb0003.jpg” />
  <SE name=“thumb_320_240” value=“http://static.kickapps.com/kickapps/images/videos/289_tmb/289_tmb0003.jpg” />
  <SE name=“thumb_48_48” value=“http://static.kickapps.com/kickapps/images/videos/289_tmb/289_tmb0003.jpg” />
  <SE name=“uploadedByName” value=“Steve” />
  <SE name=“url” value=“http://affiliate.kickapps.com/kickapps/service/
  displayMediaPlayPage.kickAction?mediaId=289&mediaType=VIDEO&as=42&b=3264” />
  <SE name=“uploadedByThumbnail” value=“http://static.kickapps.com/kickapps/images/42/users/Steve_42_buddyIcon.jpg” />
  <SE name=“id” value=“289” />
      </E>
- <E name=“video” value=“”>
  <SE name=“views” value=“20” />
  <SE name=“name” value=“Airline commercial” />
  <SE name=“description” value=“Funny commercial” />
  <SE name=“dateCreated” value=“Wed, Jul 12, 08:55 AM” />
  <SE name=“votes” value=“1” />
  <SE name=“rating” value=“2.0” />
  <SE name=“uploadedByUrl” value=“http://affiliate.kickapps.com/kickapps/service/displayKickPlace.kickAction?u=173&as=42” />
  <SE name=“count” value=“3” />
  <SE name=“thumbnail” value=“http://static.kickapps.com/kickapps/images/videos/290_tmb/290_tmb0000.jpg” />
  <SE name=“thumb_100_75” value=“http://static.kickapps.com/kickapps/images/videos/290_tmb/290_tmb0000.jpg” />
  <SE name=“thumb_160_120” value=“http://static.kickapps.com/kickapps/images/videos/290_tmb/290_tmb0000.jpg” />
  <SE name=“thumb_320_240” value=“http://static.kickapps.com/kickapps/images/videos/290_tmb/290_tmb0000.jpg” />
  <SE name=“thumb_48_48” value=“http://static.kickapps.com/kickapps/images/videos/290_tmb/290_tmb0000.jpg” />
  <SE name=“uploadedByName” value=“Steve” />
  <SE name=“url” value=“http://affiliate.kickapps.com/kickapps/service/
  displayMediaPlayPage.kickAction?mediaId=290&mediaType=VIDEO&as=42&b=3264” />
  <SE name=“uploadedByThumbnail” value=“http://static.kickapps.com/kickapps/images/42/users/Steve_42_buddyIcon.jpg” />
  <SE name=“id” value=“290” />
      </E>
- <E name=“video” value=“”>
  <SE name=“views” value=“11” />
  <SE name=“name” value=“Sports Bloopes” />
  <SE name=“description” value=“Very funny sports bloopers” />
  <SE name=“dateCreated” value=“Wed, Jul 12, 08:57 AM” />
  <SE name=“votes” value=“0” />
  <SE name=“rating” value=“0.0” />
  <SE name=“uploadedByUrl” value=“http://affiliate.kickapps.com/kickapps/service/displayKickPlace.kickAction?u=173&as=42” />
  <SE name=“count” value=“4” />
  <SE name=“thumbnail” value=“http://static.kickapps.com/kickapps/images/videos/291_tmb/291_tmb0003.jpg” />
  <SE name=“thumb_100_75” value=“http://static.kickapps.com/kickapps/images/videos/291_tmb/291_tmb0003.jpg” />
  <SE name=“thumb_160_120” value=“http://static.kickapps.com/kickapps/images/videos/291_tmb/291_tmb0003.jpg” />
  <SE name=“thumb_320_240” value=“http://static.kickapps.com/kickapps/images/videos/291_tmb/291_tmb0003.jpg” />
  <SE name=“thumb_48_48” value=“http://static.kickapps.com/kickapps/images/videos/291_tmb/291_tmb0003.jpg” />
  <SE name=“uploadedByName” value=“Steve” />
  <SE name=“url” value=“http://affiliate.kickapps.com/kickapps/service/
  displayMediaPlayPage.kickAction?mediaId=291&mediaType=VIDEO&as=42&b=3264” />
  <SE name=“uploadedByThumbnail” value=“http://static.kickapps.com/kickapps/images/42/users/Steve_42_buddyIcon.jpg” />
  <SE name=“id” value=“291” />
      </E>
- <E name=“video” value=“”>
  <SE name=“views” value=“25” />
  <SE name=“name” value=“Demo Fish” />
  <SE name=“description” value=“These aren't real fish, they're demo fish. Check these little critters out!” />
  <SE name=“dateCreated” value=“Wed, Jul 12, 09:02 AM” />
  <SE name=“votes” value=“2” />
  <SE name=“rating” value=“4.0” />
  <SE name=“uploadedByUrl” value=“http://affiliate.kickapps.com/kickapps/service/displayKickPlace.kickAction?u=174&as=42” />
  <SE name=“count” value=“5” />
  <SE name=“thumbnail” value=“http://static.kickapps.com/kickapps/images/videos/292_tmb/292_tmb0003.jpg” />
  <SE name=“thumb_100_75” value=“http://static.kickapps.com/kickapps/images/videos/292_tmb/292_tmb0003.jpg” />
  <SE name=“thumb_160_120” value=“http://static.kickapps.com/kickapps/images/videos/292_tmb/292_tmb0003.jpg” />
  <SE name=“thumb_320_240” value=“http://static.kickapps.com/kickapps/images/videos/292_tmb/292_tmb0003.jpg” />
  <SE name=“thumb_48_48” value=“http://static.kickapps.com/kickapps/images/videos/292_tmb/292_tmb0003.jpg” />
  <SE name=“uploadedByName” value=“Jeff” />
  <SE name=“url” value=“http://affiliate.kickapps.com/kickapps/service/
  displayMediaPlayPage.kickAction?mediaId=292&mediaType=VIDEO&as=42&b=3264” />
  <SE name=“uploadedByThumbnail” value=“http://static.kickapps.com/kickapps/images/42/users/Jeff_42_buddyIcon.jpg” />
  <SE name=id” value=“292” />
      </E>
- <E name=“video” value=“”>
  <SE name=“views” value=“10” />
  <SE name=“name” value=“Fish” />
  <SE name=“description” value=“” />
  <SE name=“dateCreated” value=“Wed, Jul 12, 09:21 AM” />
  <SE name=“votes” value=“1” />
  <SE name=“rating” value=“4.0” />
  <SE name=“uploadedByUrl” value=“http://affiliate.kickapps.com/kickapps/service/displayKickPlace.kickAction?u=175&as=42” />
  <SE name=“count” value=“6” />
  <SE name=“thumbnail” value=“http://static.kickapps.com/kickapps/images/videos/294_tmb/294_tmb0003.jpg” />
  <SE name=“thumb_100_75” value=“http://static.kickapps.com/kickapps/images/videos/294_tmb/294_tmb0003.jpg” />
  <SE name=“thumb_160_120” value=“http://static.kickapps.com/kickapps/images/videos/294_tmb/294_tmb0003.jpg” />
  <SE name=“thumb_320_240” value=“http://static.kickapps.com/kickapps/images/videos/294_tmb/294_tmb0003.jpg” />
  <SE name=“thumb_48_48” value=“http://static.kickapps.com/kickapps/images/videos/294_tmb/294_tmb0003.jpg” />
  <SE name=“uploadedByName” value=“angie” />
  <SE name=“url” value=“http://affiliate.kickapps.com/kickapps/service/
  displayMediaPlayPage.kickAction?mediaId=294&mediaType=VIDEO&as=42&b=3264” />
  <SE name=“uploadedByThumbnail” value=“http://static.kickapps.com/kickapps/images/42/users/angie_42_buddyIcon.jpg” />
  <SE name=“id” value=“294” />
      </E>
- <E name=“video” value=“”>
  <SE name=“views” value=“22” />
  <SE name=“name” value=“Whale Gone Wild” />
  <SE name=“description” value=“This whale didn't mean any harm but jumped right on to a kayak.” />
  <SE name=“dateCreated” value=“Wed, Jul 12, 09:22 AM” />
  <SE name=“votes” value=“0” />
  <SE name=“rating” value=“0.0” />
  <SE name=“uploadedByUrl” value=“http://affiliate.kickapps.com/kickapps/service/displayKickPlace.kickAction?u=174&as=42” />
  <SE name=“count” value=“7” />
  <SE name=“thumbnail” value=“http://static.kickapps.com/kickapps/images/videos/295_tmb/295_tmb0003.jpg” />
  <SE name=“thumb_100_75” value=“http://static.kickapps.com/kickapps/images/videos/295_tmb/295_tmb0003.jpg” />
  <SE name=“thumb_160_120” value=“http://static.kickapps.com/kickapps/images/videos/295_tmb/295_tmb0003.jpg” />
  <SE name=“thumb_320_240” value=“http://static.kickapps.com/kickapps/images/videos/295_tmb/295_tmb0003.jpg” />
  <SE name=“thumb_48_48” value=“http://static.kickapps.com/kickapps/images/videos/295_tmb/295_tmb0003.jpg” />
  <SE name=“uploadedByName” value=“Jeff” />
  <SE name=“url” value=“http://affiliate.kickapps.com/kickapps/service/
  displayMediaPlayPage.kickAction?mediaId=295&mediaType=VIDEO&as=42&b=3264” />
  <SE name=“uploadedByThumbnail” value=“http://static.kickapps.com/kickapps/images/42/users/Jeff_42_buddyIcon.jpg” />
  <SE name=“id” value=“295” />
      </E>
- <E name=“video” value=“”>
  <SE name=“views” value=“11” />
  <SE name=“name” value=“Grr....argh” />
  <SE name=“description” value=“” />
  <SE name=“dateCreated” value=“Wed, Jul 12, 09:26 AM” />
  <SE name=“votes” value=“1” />
  <SE name=“rating” value=“5.0” />
  <SE name=“uploadedByUrl” value=“http://affiliate.kickapps.com/kickapps/service/displayKickPlace.kickAction?u=175&as=42” />
  <SE name=“count” value=“8” />
  <SE name=“thumbnail” value=“http://static.kickapps.com/kickapps/images/videos/296_tmb/296_tmb0003.jpg” />
  <SE name=“thumb_100_75” value=“http://static.kickapps.com/kickapps/images/videos/296_tmb/296_tmb0003.jpg” />
  <SE name=“thumb_160_120” value=“http://static.kickapps.com/kickapps/images/videos/296_tmb/296_tmb0003.jpg” />
  <SE name=“thumb_320_240” value=“http://static.kickapps.com/kickapps/images/videos/296_tmb/296_tmb0003.jpg” />
  <SE name=“thumb_48_48” value=“http://static.kickapps.com/kickapps/images/videos/296_tmb/296_tmb0003.jpg” />
  <SE name=“uploadedByName” value=“angie” />
  <SE name=“url” value=“http://affiliate.kickapps.com/kickapps/service/
  displayMediaPlayPage.kickAction?mediaId=296&mediaType=VIDEO&as=42&b=3264” />
  <SE name=“uploadedByThumbnail” value=“http://static.kickapps.com/kickapps/images/42/users/angie_42_buddyIcon.jpg” />
  <SE name=“id” value=“296” />
      </E>
- <E name=“video” value=“”>
  <SE name=“views” value=“10” />
  <SE name=“name” value=“Fanta Sneeze” />
  <SE name=“description” value=“” />
  <SE name=“dateCreated” value=“Wed, Jul 12, 09:33 AM” />
  <SE name=“votes” value=“0” />
  <SE name=“rating” value=“0.0” />
  <SE name=“uploadedByUrl” value=“http://affiliate.kickapps.com/kickapps/service/displayKickPlace.kickAction?u=175&as=42” />
  <SE name=“count” value=“9” />
  <SE name=“thumbnail” value=“http://static.kickapps.com/kickapps/images/videos/298_tmb/298_tmb0003.jpg” />
  <SE name=“thumb_100_75” value=“http://static.kickapps.com/kickapps/images/videos/298_tmb/298_tmb0003.jpg” />
  <SE name=“thumb_160_120” value=“http://static.kickapps.com/kickapps/images/videos/298_tmb/298_tmb0003.jpg” />
  <SE name=“thumb_320_240” value=“http://static.kickapps.com/kickapps/images/videos/298_tmb/298_tmb0003.jpg” />
  <SE name=“thumb_48_48” value=“http://static.kickapps.com/kickapps/images/videos/298_tmb/298_tmb0003.jpg” />
  <SE name=“uploadedByName” value=“angie” />
  <SE name=“url” value=“http://affiliate.kickapps.com/kickapps/service/
  displayMediaPlayPage.kickAction?mediaId=298&mediaType=VIDEO&as=42&b=3264” />
  <SE name=“uploadedByThumbnail” value=“http://static.kickapps.com/kickapps/images/42/users/angie_42_buddyIcon.jpg” />
  <SE name=“id” value=“298” />
      </E>
  <E name=“largeListUrl” value=“http://affiliate.kickapps.com/kickapps/service/displayLargeList.kickAction?b=3264&as=42” />
      </W>
```

What is claimed is:

1. A hosted application services platform that facilitates the proliferation of web-based components, the system comprising:
a component design module configured to:
a. facilitate the design of a web-based component, the component comprising a feature set, an attribute set and at least one user control object, the feature set and attribute set being determined during the design of the components; and
b. facilitate modifications to the feature set and the attribute set after the component has been deployed; and
a code-generation module configured to generate an instruction set which is interpretable to express the feature set, the attribute set and the control object for the component;
wherein the control object facilitates the seamless copying of the component from a first website to a second website whereby subsequent to such copying, modifications to one or more of the feature set or the attribute set are automatically incorporated into the copied component whenever the component is expressed.

2. The hosted application services platform of claim 1 further comprising a database for storing the feature sets and attribute sets of the component as periodically modified.

3. The hosted application services platform of claim 2 wherein the code-generation module is configured to retrieve the feature sets and attribute sets from the database prior to generating the instruction set.

4. The hosted application services platform of claim 1 wherein the component is an advertisement.

5. The hosted application services platform of claim 1 wherein the component, when expressed, presents media content.

6. The hosted application services platform of claim 1 wherein the feature set comprises one or more of an upload feature, a view media feature, a polling feature or a navigation feature.

7. The hosted application services platform of claim 6 wherein the feature set comprises a navigation feature that directs the client application to the first website.

8. The hosted application services platform of claim 7 wherein the component provides access to an application.

9. The hosted application services platform of claim 1 wherein the attribute set comprises one or more of a size, a background color, a skin, a background image and included text.

10. The hosted application services platform of claim 1 wherein the instruction set comprises javascript.

11. The hosted application services platform of claim 1 wherein the instruction set comprises mark-up instructions.

12. The hosted application services platform of claim 1 wherein the code-generation module updatably expresses the feature set, the attribute set and the control object for the component such that their expression reflects any modifications thereto.

13. The hosted application services platform of claim 1 wherein the instruction set is portable among numerous websites.

14. The hosted application services platform of claim 1 wherein the control object facilitates the seamless copying of the component from the second website to a third website whereby subsequent updates to one or more of the feature set or the attribute set are automatically incorporated into the copied component whenever the copied component is expressed.

15. A method for facilitating the proliferation of dynamic web-based components, the method comprising:
facilitating the design of a web-based component, the component comprising a feature set and an attribute set, the feature set and attribute set being determined during the design of the components;
facilitating modification of the feature set and the attribute set after the component has been deployed;
generating an instruction set which is interpretable to express the feature set and the attribute set for the component; and
facilitating the seamless copying of the component from a first website to a second website whereby subsequent to such copying, modifications to one or more of the feature set or the attribute set are automatically incorporated into the copied component whenever the component is expressed.

16. The method of claim 15 further comprising providing a control object to initiate the seamless copying from the first website to a second website.

17. The method of claim 18 further comprising storing, in a database, the feature sets and attribute sets of the component as periodically modified.

18. The method of claim 19 further comprising retrieving the feature sets and attribute sets from the database prior to generating the instruction set.

19. The method of claim 18 wherein the component is an advertisement.

20. The method of claim 18 wherein the component is configured to display media content.

21. The method of claim 18 wherein the feature set comprises one or more of an upload feature, a view media feature, a polling feature or a navigation feature.

22. The method of claim 21 wherein the feature set comprises a navigation feature that directs the client application to the first website.

23. The method of claim 22 wherein the first website provides access to an application.

24. The method of claim 23 wherein the application facilitates the creation of user-specific web pages.

25. The method of claim 24 wherein the application facilitates the uploading of media content to the user-specific web pages.

26. The method of claim 24 wherein the application facilitates the posting of text to the user-specific web pages.

27. The method of claim 18 wherein the attribute set comprises one or more of a size, a background color, a skin, a background image and included text.

28. The method of claim 18 wherein the instruction set comprises javascript.

29. The method of claim 18 wherein the instruction set comprises mark-up instructions.

30. The method of claim 18 wherein the feature set and the attribute set for the component are updatably expressed such that their expression reflects any modifications thereto.

31. The method of claim 18 wherein the seamless copying of the component comprises copying the instruction set from the first website to the second website.

32. The method of claim 31 wherein the instruction set comprises a comprises a hostname and unique component identifier.

33. The method of claim 18 wherein the instruction set is portable among numerous websites.

34. The method of claim 18 wherein the control object further facilitates the seamless copying of the component from the second website to a third website whereby subsequent updates to one or more of the feature set or the attribute set are automatically incorporated into the copied component whenever the copied component is expressed.

35. A method for facilitating the proliferation of dynamic web-based components, the method comprising:
designing a dynamic web-based component, the component comprising a feature set, an attribute set and at least one user control object for the component; and
deploying the component on a first website whereby (i) visitors to the first website are permitted to copy the component to a second website and (ii) subsequent updates to one or more of the feature set or the attribute set are automatically incorporated into the copies of the component when expressed.
